(19) United States
(12) Patent Application Publication
(10) Pub. No.: US 2026/0064551 A1
(43) Pub. Date: Mar. 5, 2026

(54) SYSTEM AND METHOD FOR PROVIDING DATA WATCH RULES AND NOTIFICATIONS FOR USE WITH A DATA ANALYTICS ENVIRONMENT

(71) Applicant: ORACLE INTERNATIONAL CORPORATION, Redwood Shores, CA (US)

(72) Inventors: Abraham Vargas Torres, Zapopan (MX); Sergio Alejandro Acosta Moreno, Zapopan (MX); Ian Broyles, Nashville, TN (US); Sebastian Olivares, Zapopan (MX); Alina Fernandez, Puebla (MX); Fernando Benavides, Jalisco (MX); Jose Arellano, Mexico City (MX); Joel Hernandez, Mexico City (MX)

(21) Appl. No.: 19/189,019

(22) Filed: Apr. 24, 2025

Related U.S. Application Data
(60) Provisional application No. 63/690,584, filed on Sep. 4, 2024.

(51) Int. Cl. G06F 11/32; G06F 11/30

(52) U.S. Cl. CPC G06F 11/321; G06F 11/3065

(57) ABSTRACT

Embodiments described herein are generally related to a data analytics environment and computer-based techniques for providing data-based notifications within the data analytics environment. The technique involves establishing rules based on specific data and conditions such that, when the specific data meets the conditions, a notification is provided to a user. The technique involves receiving user input indicative of parameters for a data watch construct, configuring the data watch construct based on the user input, receiving a trigger for a notification from the data watch construct when a configured condition is satisfied, and displaying the notification to the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CLAIM OF PRIORITY AND CROSS-REFERENCE TO RELATED APPLICATIONS

This application claims the benefit of priority to U.S. Provisional Patent Application titled “SYSTEM AND METHOD FOR PROVIDING DATAWATCH RULES AND NOTIFICATIONS FOR USE WITH A DATA ANALYTICS ENVIRONMENT”, Application No. 63/690,584, filed Sep. 4, 2024; which above application and the contents thereof are herein incorporated by reference.

### TECHNICAL FIELD

Embodiments described herein are generally related to data analytics environments, and are particularly directed to systems and methods for providing data watch rules and notifications for use with a data analytics environment.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

### SUMMARY

Embodiments described herein are generally related to data analytics environments, and are particularly directed to systems and methods for providing data watch rules and notifications for use with a data analytics environment.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates an example system for providing data watch rules and notifications in a data analytics environment, in accordance with an embodiment.

FIG. 12 illustrates use of a tool for providing data watch rules and notifications for use with a data analytics environment, in accordance with an embodiment.

FIG. 13 further illustrates use of a tool for providing data watch rules and notifications for use with a data analytics environment, in accordance with an embodiment.

FIG. 14 further illustrates use of a tool for providing data watch rules and notifications for use with a data analytics environment, in accordance with an embodiment.

FIG. 15 further illustrates use of a tool for providing data watch rules and notifications for use with a data analytics environment, in accordance with an embodiment.

FIG. 16 further illustrates use of a tool for providing data watch rules and notifications for use with a data analytics environment, in accordance with an embodiment.

FIG. 17 further illustrates use of a tool for providing data watch rules and notifications for use with a data analytics environment, in accordance with an embodiment.

FIG. 18 further illustrates use of a tool for providing data watch rules and notifications for use with a data analytics environment, in accordance with an embodiment.

FIG. 19 further illustrates use of a tool for providing data watch rules and notifications for use with a data analytics environment, in accordance with an embodiment.

FIG. 20 illustrates a process for providing data watch rules and notifications for use with a data analytics environment, in accordance with an embodiment.

FIG. 21 illustrates a process for providing data watch rules and notifications for use with a data analytics environment, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

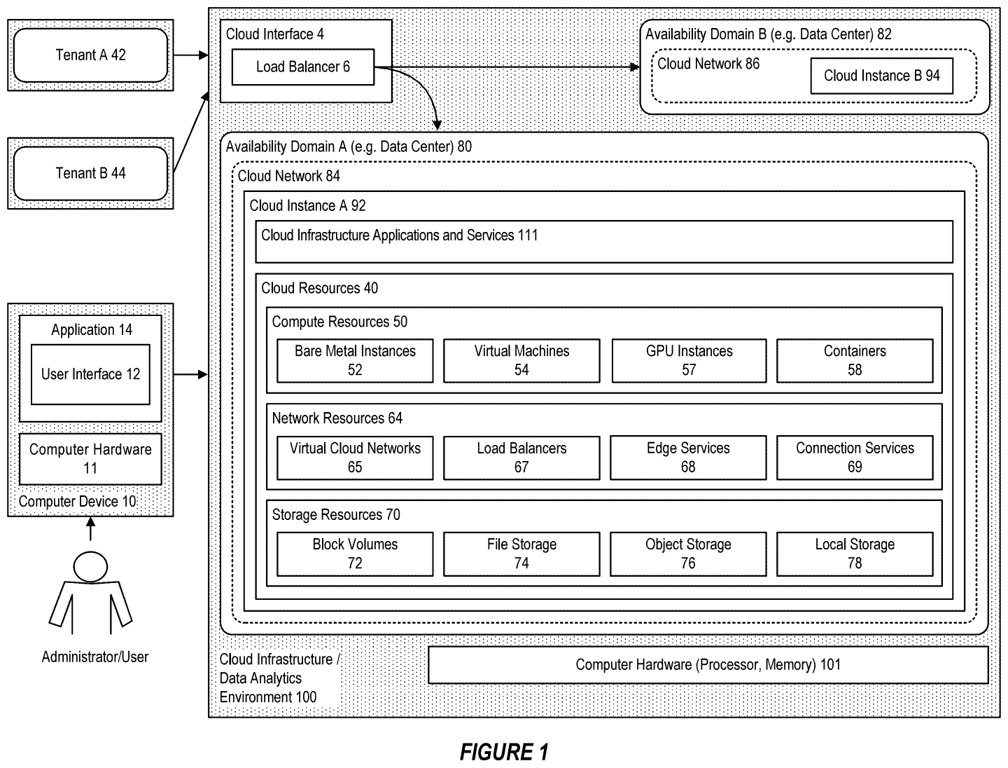

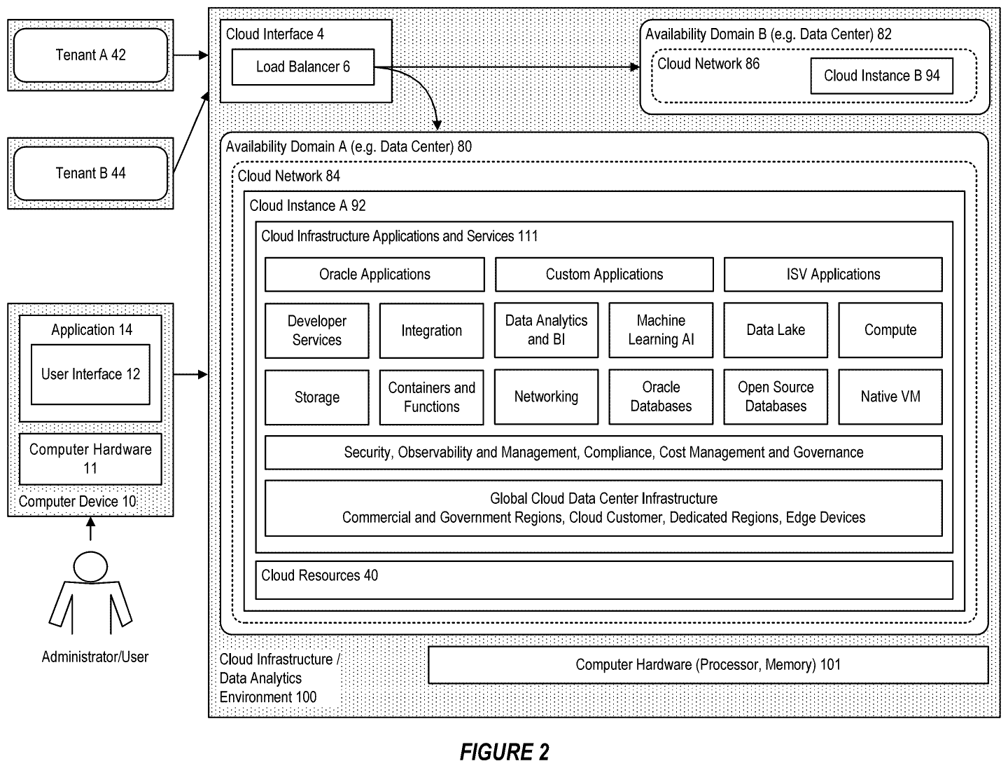

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

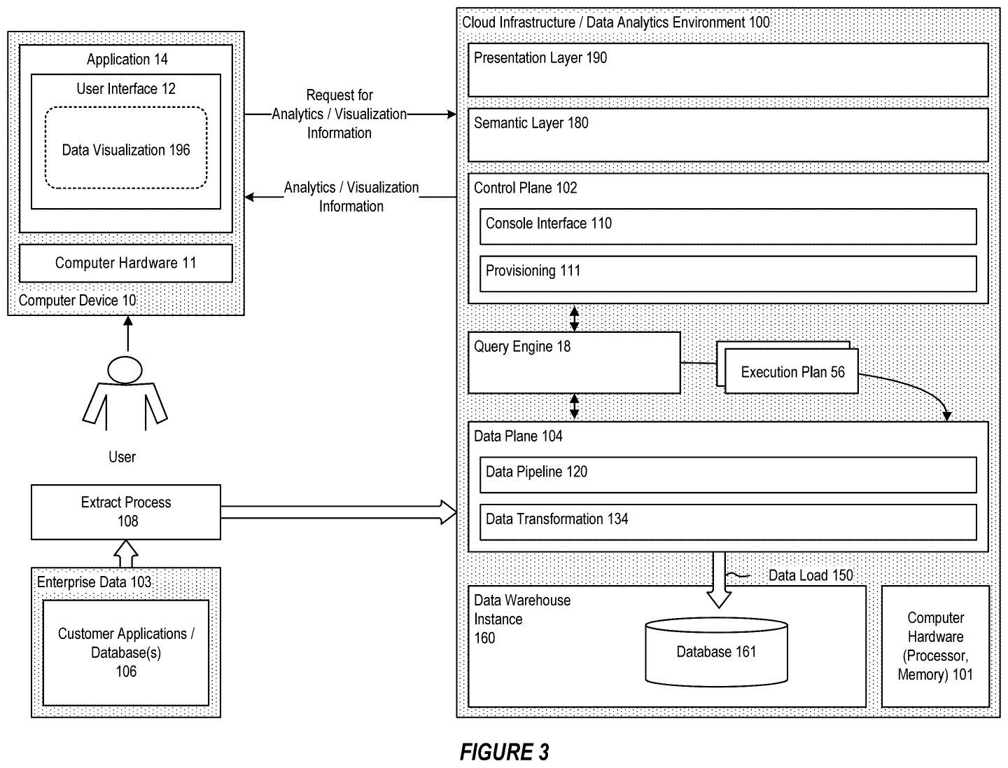

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

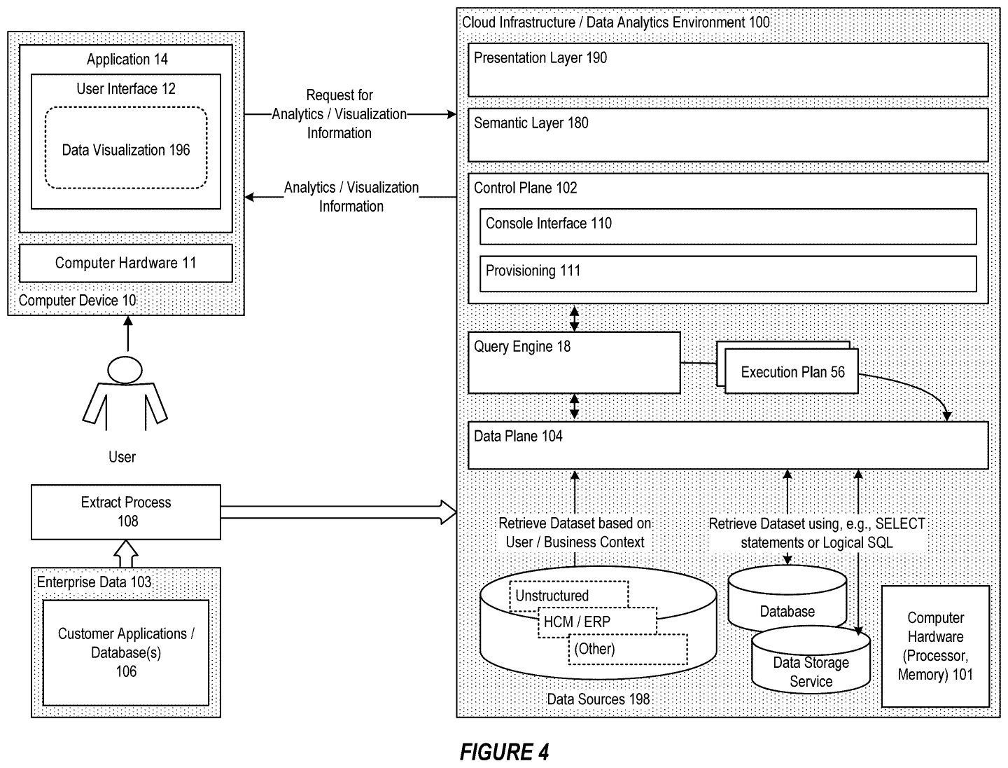

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

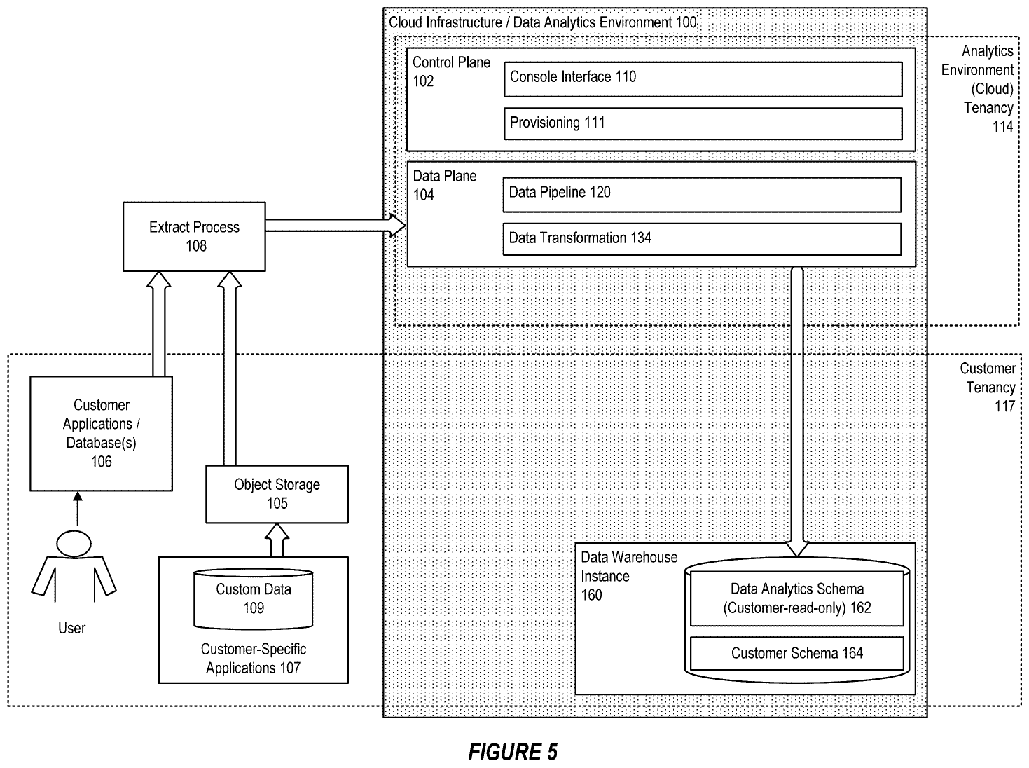

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

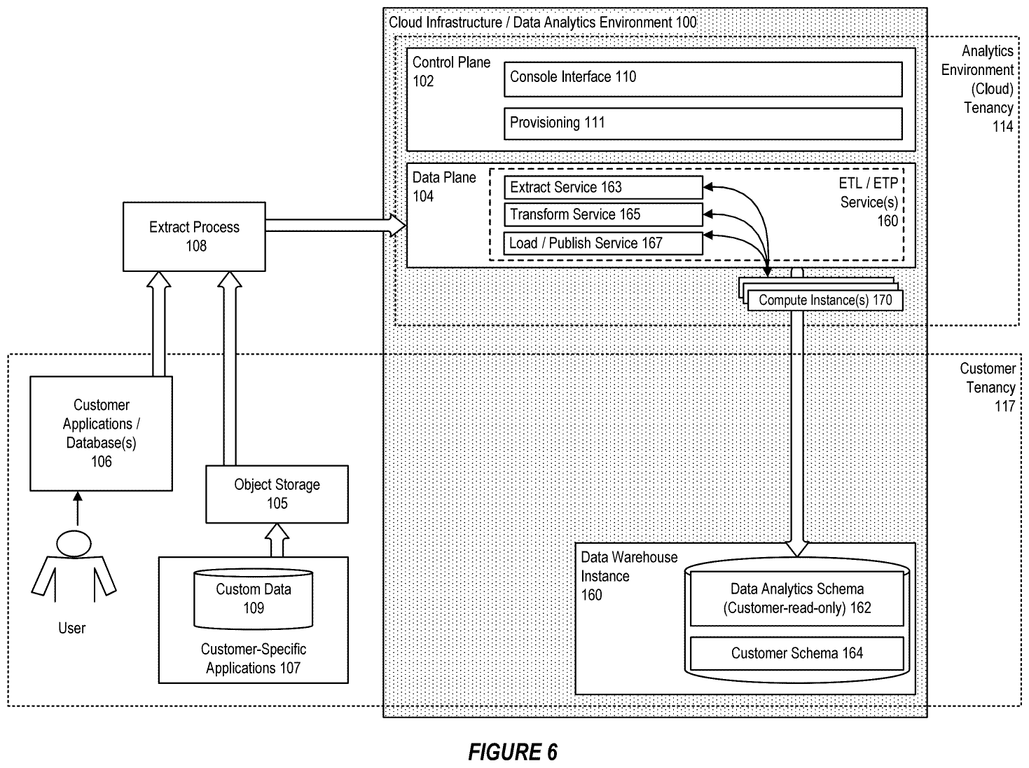

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

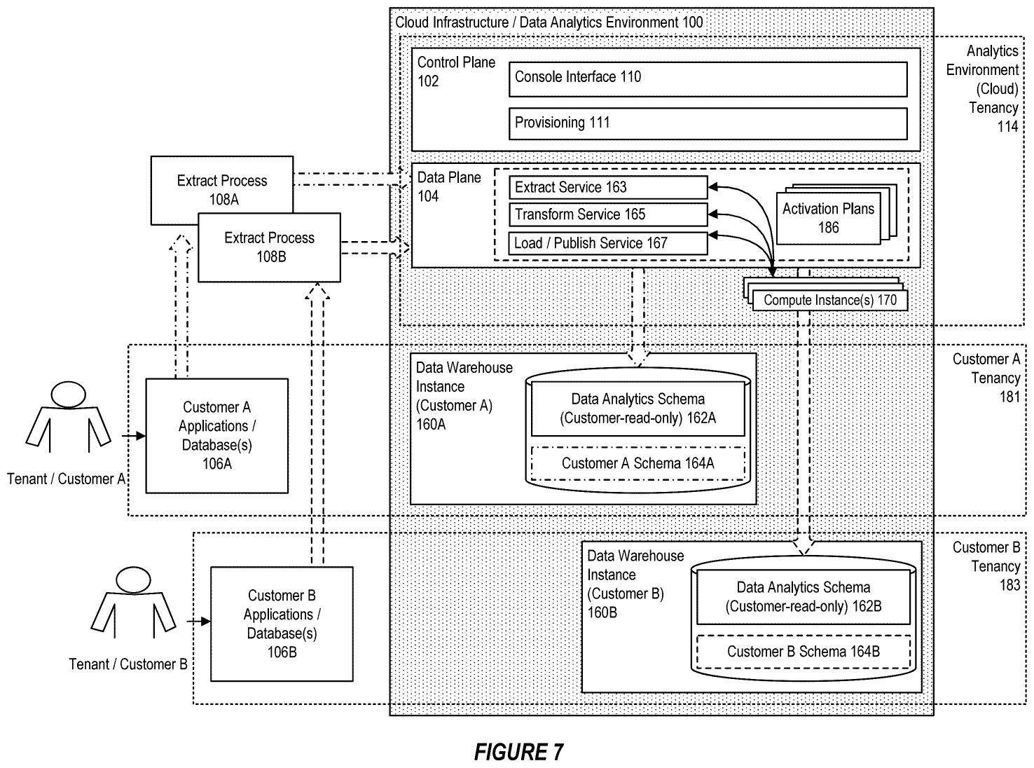

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

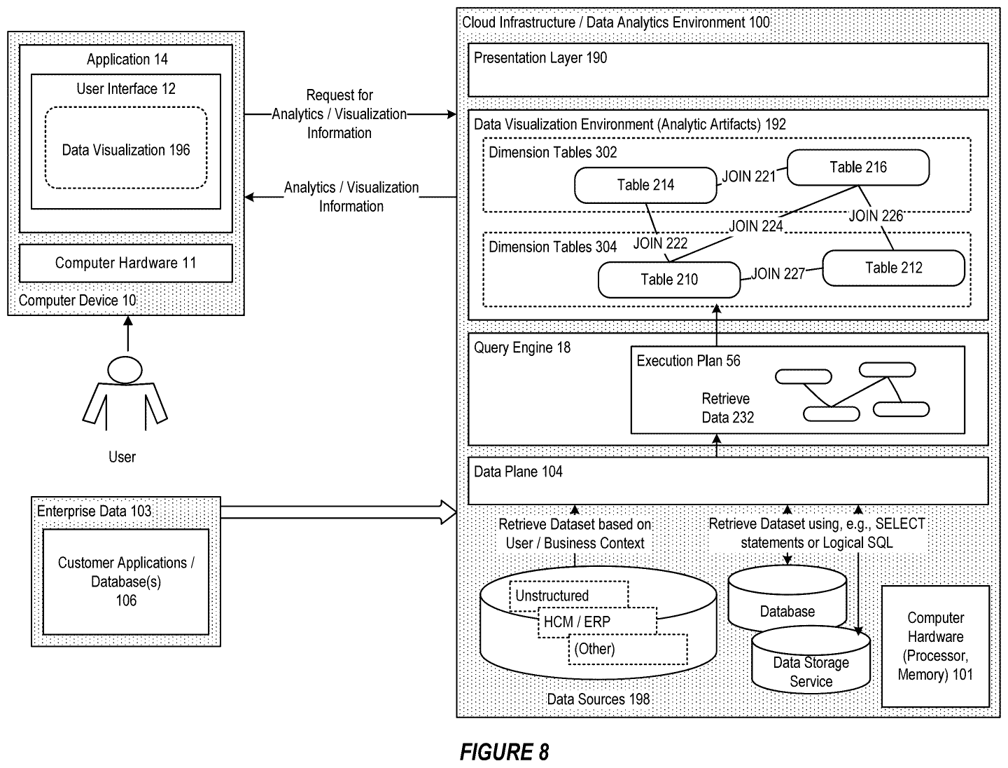

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

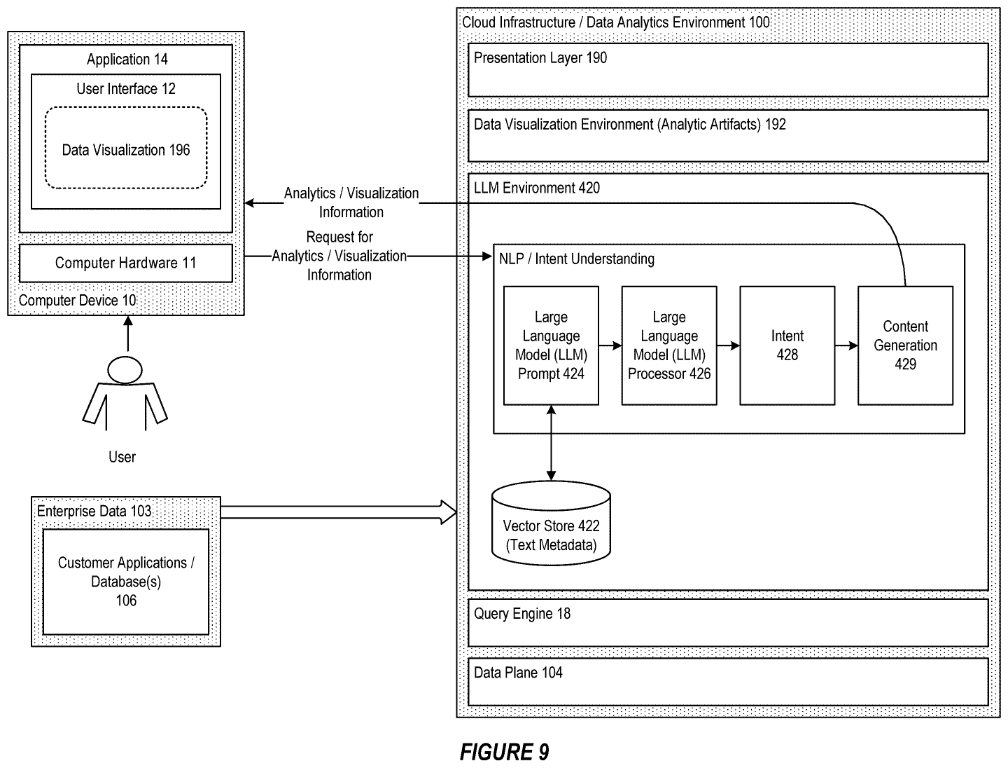

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

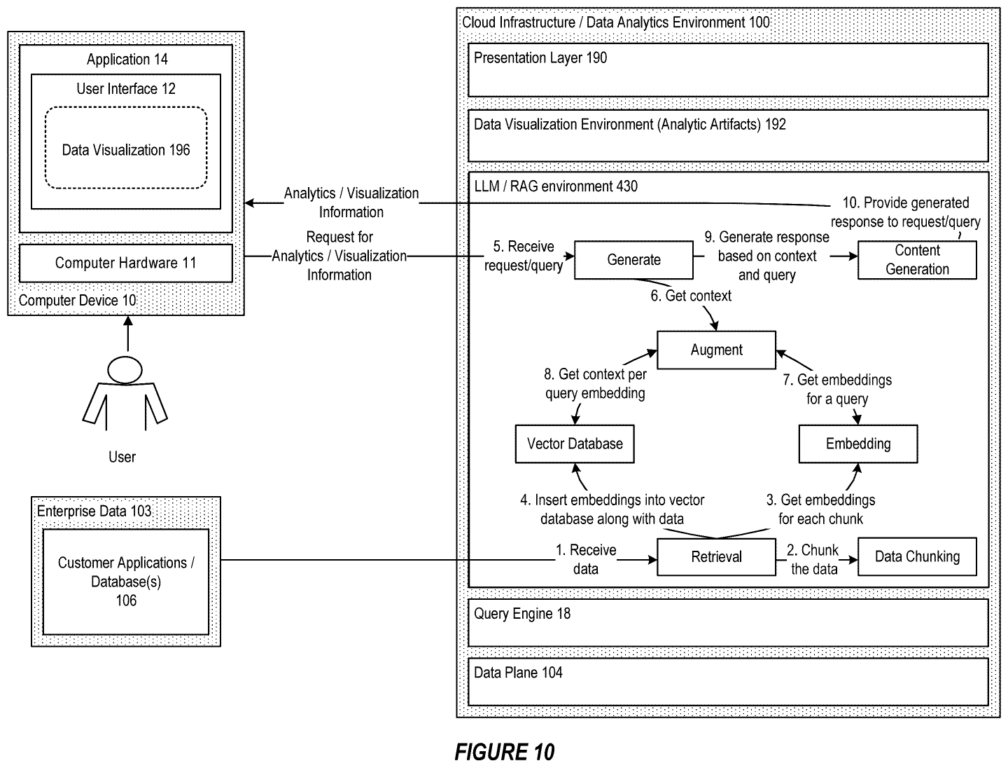

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process:

Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

### Data Watch Rules and Notifications

Typically, to consult any data values in a dataset maintained by a data analytics environment, users create or open a workbook and/or add a visualization to a watchlist. Then, the users log into a data visualization environment (provided by the data analytics environment, for example) and consult information periodically (e.g., n times) until the information of interest gets updated. Conventional systems do not automatically notify users when a condition is met. Rather, users must keep consulting their information manually.

According to an aspect, benefits of a mobile ecosystem and an analytics mobile native application are taken advantage of to enable rules to be created and/or utilized for a selected dataset in order to provide notifications when a specific condition is met.

In accordance with another aspect, a user can initiate a data watch process for a dataset source by selecting columns and/or specific data. In some examples, a part of the alarm or notification configuration involves choosing a date and/or value parameter. This parameter can be the date and/or value in the data be reached to trigger the alarm. In another example, a user can select a column and/or specific data and receive the actual value periodically (e.g., every ‘n’ time) without needing a condition to be met. That is, the data is sent according to a recurrent interval.

In accordance with another aspect, once configuration is complete, an alarm or notification (e.g., data watch) process can be created. This process stores the current values locally in the application to be compared with the latest server values as needed in the future when the alarm is triggered.

In accordance with an embodiment, the analytics mobile native application can fetch and compare values to determine if a condition is met.

In accordance with another aspect, when a notification is triggered and presented, the application fetches the data according to the selected columns to present a visualization for this specific case. Further, a tooltip can be enabled to highlight the specific data and/or value selected.

In accordance with an embodiment, the systems and methods herein can provide reactive notifications that alert users to simplify their information consultation and align with the expected functionality of mobile devices. This allows users to focus on creating the necessary rules and triggers for their data while the platform/system notifies them whenever a configured condition is met.

In accordance with an embodiment, the systems and methods can automate a process for users.

In accordance with an embodiment, the systems and methods increase the scope of the analytics mobile application.

In accordance with an embodiment, utilizing the systems and methods disclosed herein, a user does not need to create a visualization via a workbook or watchlist. Rather, the data watch and notification functionality can start its process directly from a dataset source. The application (e.g., the mobile native application) can trigger a notification dialog once a condition is met. The application can also create a visualization of the actual condition configuration. This visualization is not attached to any workbook, watchlist, or report.

Utilizing conventional techniques (e.g., creating a report or workbook) from a mobile device, as currently designed, is not ideal due to the complexity involved with implementing such a large feature on a mobile platform. Instead, creating rules, as described herein, can be performed through a simple UI easily implemented on a mobile device. Further, notifications are a feature expected in any mobile application. Data watch constructs (also referred to herein as “datawatch”) and notifications address this issue by automating the entire process for the user without creating any report, workbook, or watchlist. Instead, data watch constructs focus on a dataset.

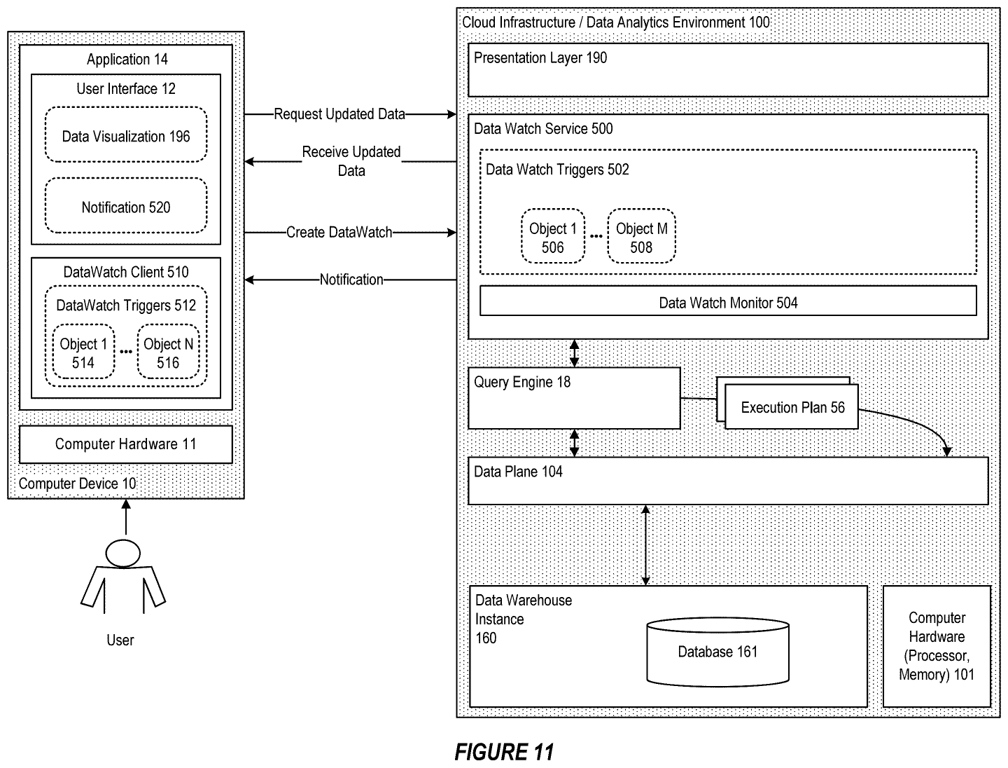

FIG. 11 illustrates an example system for providing data watch constructs and notifications with a data analytics environment, in accordance with an embodiment. As shown in FIG. 11, the data analytics environment 100 includes a data watch service 500 configured to provide rules-based data watch constructs (e.g., data-centric alarms) to users. As described herein, a data watch construct specifies a data condition or other trigger that, when satisfied, causes a notification to be displayed for the user.

In one example, data watch service 500 can provide an interface, such as an application program interface (API), to enable a user to create, delete, and/or update data watch constructs or objects. For instance, a user, via application 14 of computer device 10, can interact with data watch service 500 to manage data-focused alarms that trigger notifications to the user when a condition is met.

In another example, a data watch construct can be on-server. For instance, the data watch object can reside in the data analytics environment 100 and monitored there to determine if the conditions specified therein are satisfied. As shown in FIG. 11, the user, via application 14, can create a data watch construct in the data analytics environment 100 via the data watch service 500. A set of parameters can be input by the user and utilized to configure the data watch construct and generate a data watch object. For instance, data watch service 500 can maintain data watch triggers 502 created by the user. The data watch triggers 502 include one or more data watch objects such as object 1 506 to object M 508, where M is any integer greater than or equal to one.

To implement the data watch construct, data watch service 500 includes a data watch monitor 504. The data watch monitor 504 periodically checks data values, columns, or other segments of a data set (stored in data warehouse 160, for example) indicated by data watch triggers 502. The triggers 502, such as object 1 506 or object M 508, further specify one or more conditions. The data watch monitor 504 triggers a notification to the user (e.g., via application 14 of computer device 10) when the data values, columns, or other segments of the data set satisfy the one or more conditions of the triggers 502. In some embodiments, the periodicity with which the data watch monitor 504 checks the data set can be specified by the data watch objects. In other embodiments, the periodicity can be an independently configured parameter of data watch service 500.

In some implementation, the notification to the user enables the user to request or view a visualization 196 related to the data watch construct. In one example, the notification can provide relevant data associated with the data watch construct. In another example, the notification 520, when interacted with by the user, causes application 14 to request updated data from the data analytics environment 100 and receive the updated data in response. Subsequently, data visualization 196 based on the updated data can be displayed.

In another embodiment, a data watch construct can be on-device. For example, as shown in FIG. 11, application 510 can include a data watch client 510 via which the user can create, delete, update, and/or interact with data watch constructs or data watch triggers 512, such as data watch object 1 (also referred to as object 1) 514 through object N 516, where N is any integer greater than or equal to 1. In some embodiments, objects 514, 516 can be similar to objects 506, 508; however, objects 514, 516 are monitored and maintained by computer device 10 and objects 506, 508 are monitored and maintained by data analytics environment 100.

Application 14 can request updated data from the data analytics environment 100 and, subsequently, receive the updated data. The data watch client 510 can check the updated data to determine if conditions respectively associated with data watch objects or triggers 512 are satisfied. If a condition is met, data watch client 510 can trigger notification 520 to be displayed to the user. In some embodiments, the condition associated with a data watch trigger 5152 can be a time interval. When the time interval elapses, the condition can be determined to be satisfied, which causes the application 14 to request and receive updated data.

In an embodiment, data watch triggers 512, 502 can include configured data watch objects having one or more configured parameters. In an example, a general data watch object or trigger can specify a measure column, a dimension list, and a data source. These parameters, for instance, indicate the relevant data set associated with the data watch object. The data watch object can further indicate a rule type. For example, the rule type can be a recurrence type or a value type. One example of a recurrence type data watch object can notify about Sales on ‘Model 1’ in Latin America every Monday at 9 am. One example of a value type data watch object can notify when Units Sold from New Model in North America reach $1,000,000.

As seen in the examples above, the data watch object further includes conditional rules that, when satisfied, trigger a notification. The conditional rules, in some example, relate specifically to the measure column, dimension list, and data source specified. Further, structure of the conditional rules can vary between a recurrence type or value type object. For instance, a rule for a recurrence type object can indicate a specific date, a time, a day of the week, a repeat interval, or the like. Examples of such rules include notifying on a specific date and/or time, notify on selected days of the week at a particular time, notify every day at a particular time, etc. A rule for a value type object can indicate a threshold or milestone value and a conditional rule such as a less than, more than, or equal to. Examples include notifying whenever a selected measure value reaches a milestone (more than, less than, equal to, X value, etc.) and notifying when a particular value in a Dimension reaches a particular milestone (e.g., Revenue in Branch A is more than $300,000).

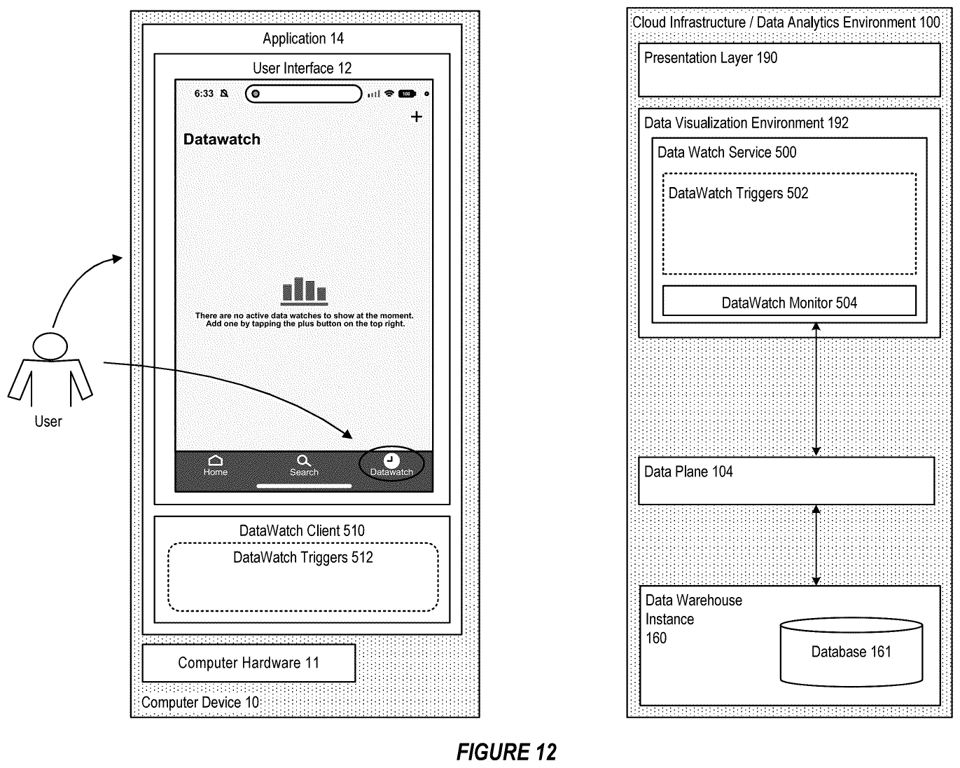

Turning to FIGS. 12-19 illustrate an example use of a tool for providing data watch rules and notifications for use with a data analytics environment, in accordance with various embodiments. According to an example, as shown in FIG. 12, a user operates computer device 10, which can be a mobile computing device. The user can open application 14 and navigate to data watch functionality (e.g., provided by data watch client 510 and/or data watch service 500). Through a data watch user interface, the user can initiate a data watch creation process.

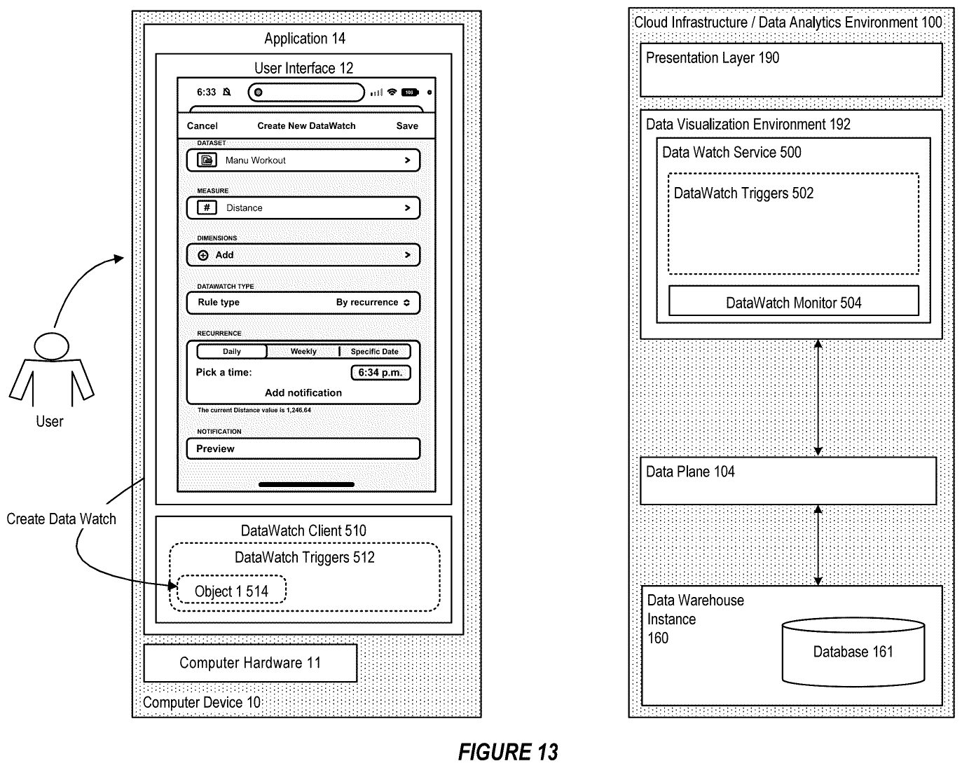

In FIG. 13, after initiating the data watch creation process, user interface 12 displays a creation user interface. The user, via the creation user interface, can input various parameters for a data watch construct. The parameters can include, for example, a data set or data source, a measure, one or more dimensions, a rule type, and/or conditional rule parameters. In the example depicted in FIG. 13, for instance, the parameters indicate a dataset ‘Manu Workout’, a measure of ‘Distance’, a rule type of ‘by recurrence’, and recurrence settings to notify daily at 6:34 pm. The notification, in an example, may state: “The current Distance value is 1,246.64.” After entry of the parameters and acceptance by the user, the application 14 can create a data watch trigger or object configured according to the input parameters. For example, as shown in FIG. 13, application 14 creates object 1 514. It is to be appreciated that, while FIG. 13 depicts an on-device object, application 14 could request creation of an on-server object based on the exemplary parameters.

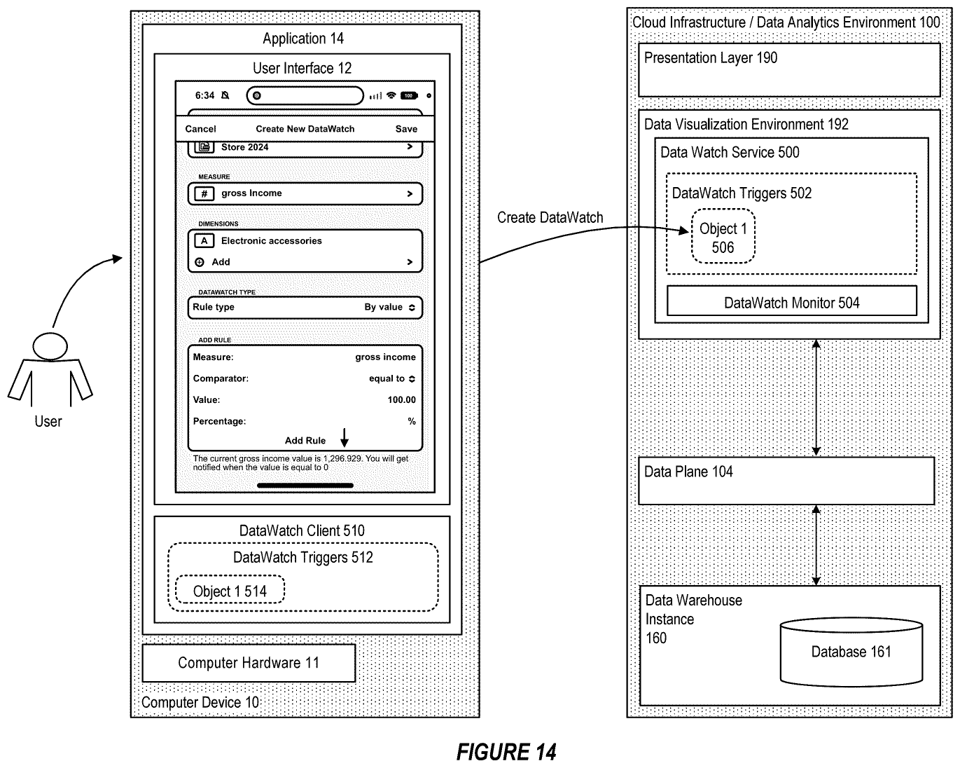

FIG. 14 illustrates creation of another data watch. In the example of FIG. 14, the dataset is specified as ‘Store 2024’, the measure is ‘gross income’, and the Dimension is ‘Electronic accessories’. In this example, the rule type is ‘by value’ and the rule parameters indicate an ‘equal to’ comparator, the measure, and a threshold or milestone value. During the creation process, as shown, a current value of the selected measure can be shown. After entry of the parameters and acceptance by the user, the application 14 can create a data watch trigger or object configured according to the input parameters. For example, as shown in FIG. 14, application 14 requests creation of object 1 506 on the data analytics environment 100. It is to be appreciated that, while FIG. 14 depicts an on-server object, application 14 could request creation of an on-device object based on the exemplary parameters.

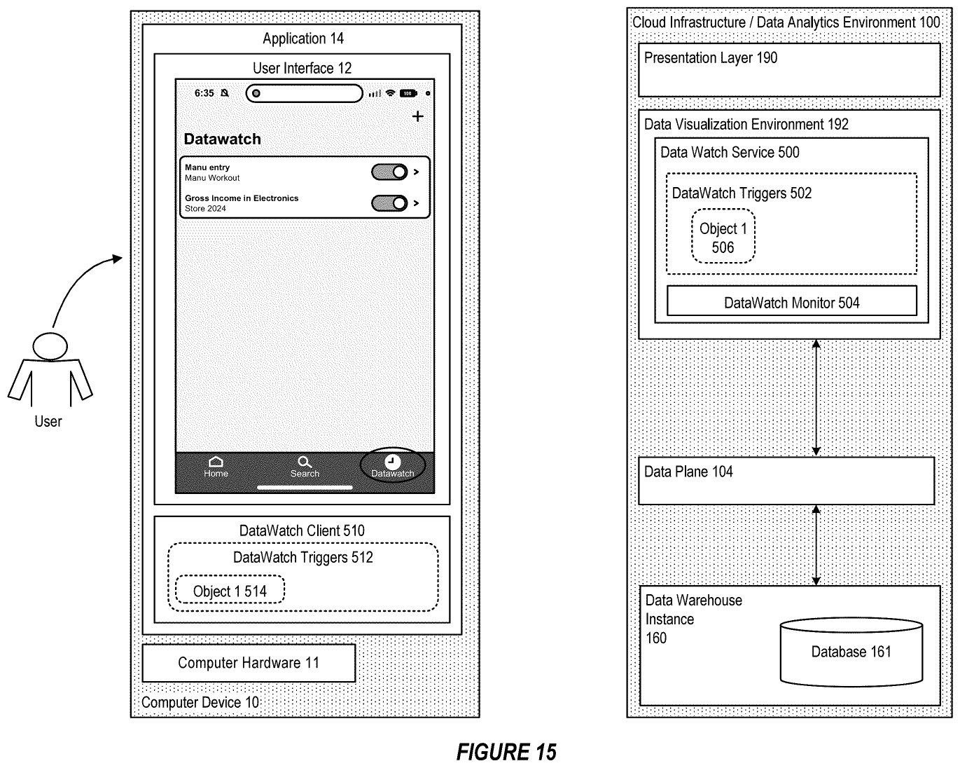

Turning to FIG. 15, after creation of one or more data watch triggers or objects, user interface 12 can display a list of configured data watch constructs. The user can toggle specific data watch triggers to enable/disable one or more triggers. When disabled, for example, notifications for a disable trigger are suppressed and/or the conditions associated therewith are not monitored.

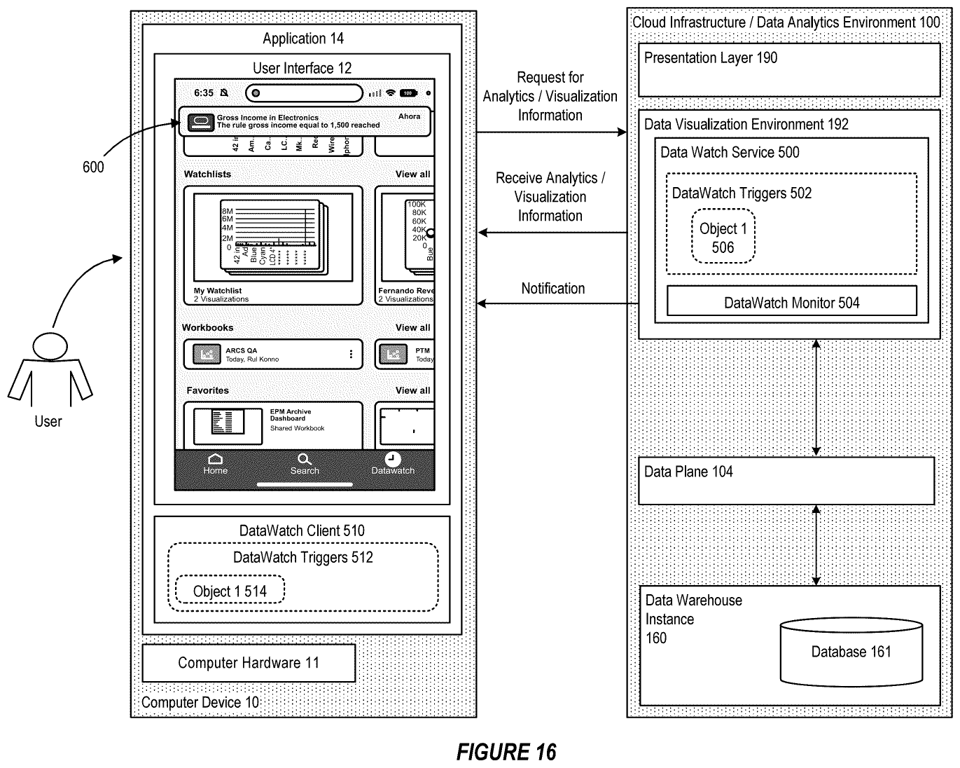

FIG. 16 illustrates an example user interface 12 where a notification 600 associated with a data watch object or trigger is displayed. Notification 600 can be triggered by object 1 506 or object 1 514. In the case of object 1 506 (e.g., an on-server object), data can be monitored (e.g., by data watch monitor 504) to determine whether the condition associated with object 506 is met. When met, the data watch service 500 triggers notification 600. In some examples, the notification message from the data watch service 500 may include updated data and/or analytics/visualization information. In other examples, the user interacts with notification 600 to cause application 14 to request and receive analytics/visualization information.

In the case of object 514 (e.g., an on-device object), data can be monitored by the data watch client 510. In one example, the application 14 can request and receive updated data periodically as shown in FIG. 11. The updated data can be reviewed to determine whether the condition associated with object 514 is met. When met, the data watch client 510 triggers notification 600.

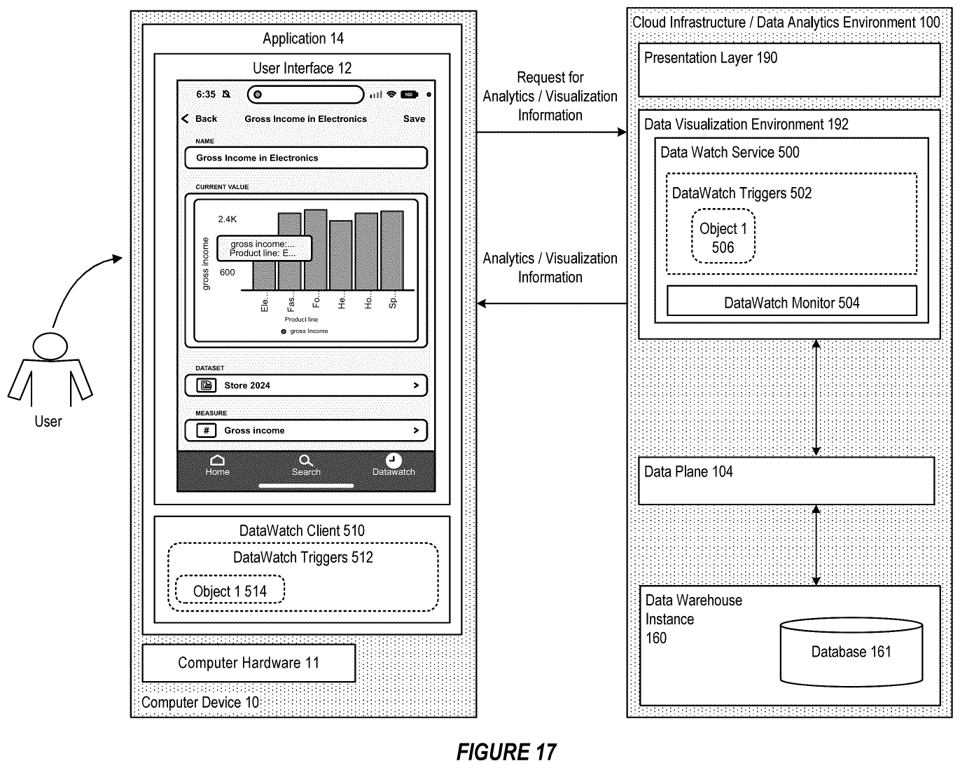

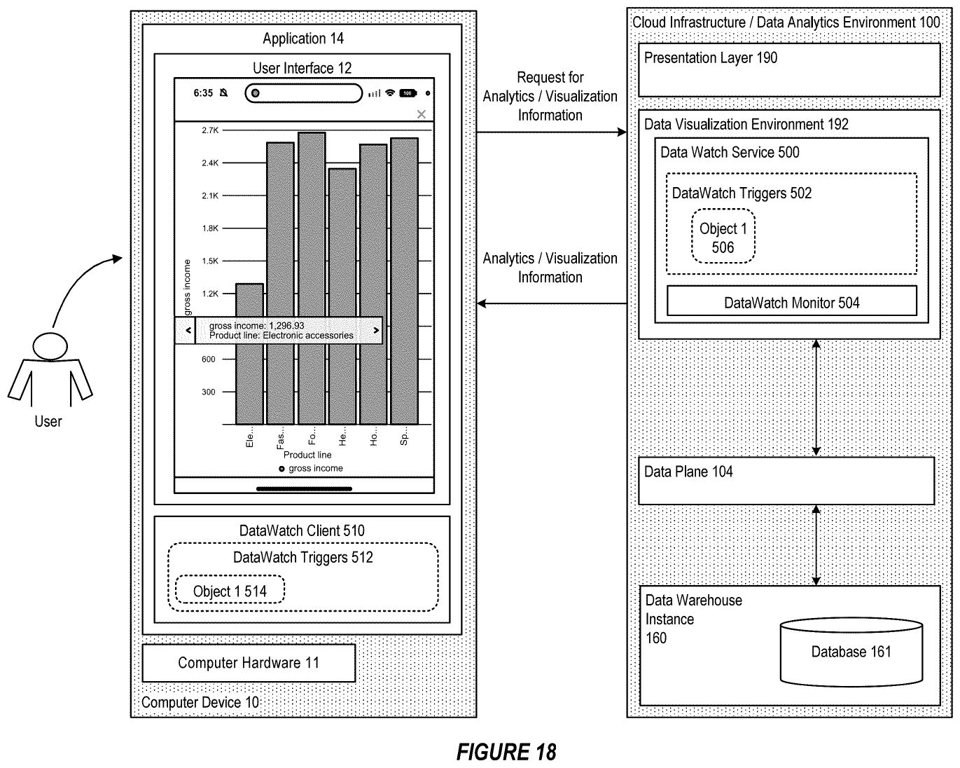

FIGS. 17 and 18 illustrates an example visualization displayed following notification 600. In one example, the application 14 can request the visualization from the data analytics environment 100 when the user interacts with notification 600. In another example, the visualization can be included in a notification trigger. As shown in FIGS. 17 and 18, a tooltip can be included in the visualization to highlight specific data associated with the data watch object.

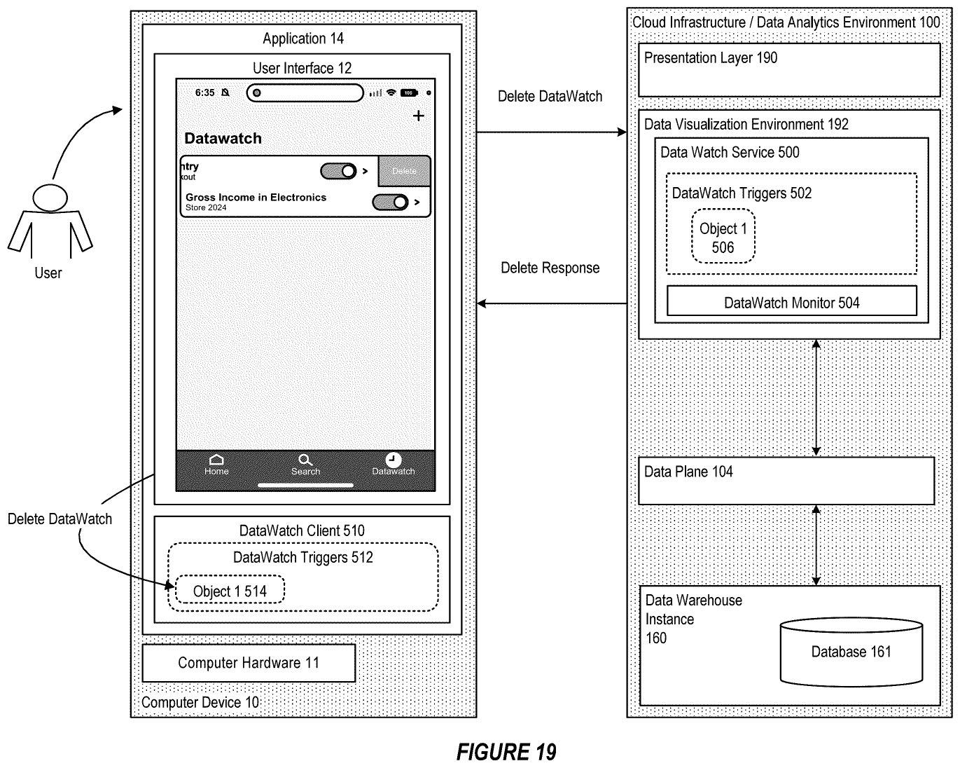

FIG. 19 depicts the list of configured data watch objects as also shown in FIG. 15. Using this interface, the user can delete a configured data watch.

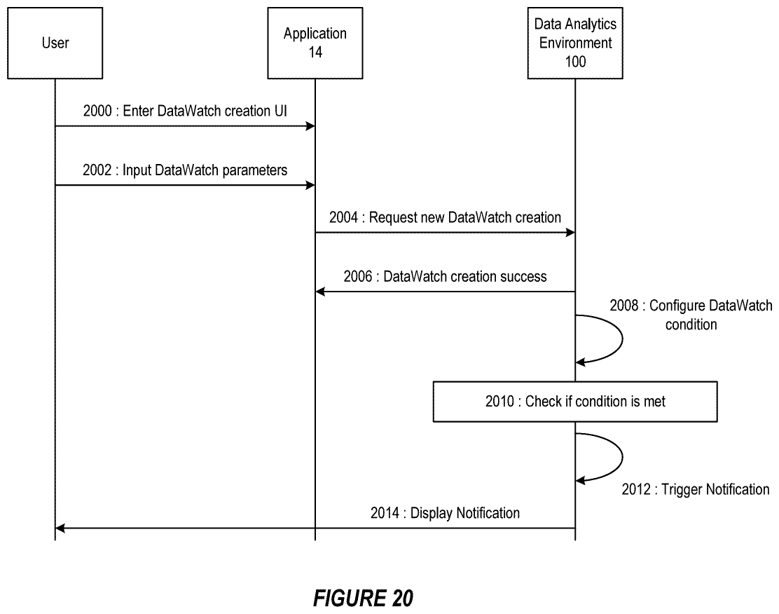

FIG. 20 illustrates an exemplary process for providing data watch rules and notifications for use with a data analytics environment, in accordance with an embodiment. In an example, FIG. 20 depicts the process for an on-server data watch object. As illustrated in FIG. 20, at 2000, the user enters the data watch creation UI of application 14. At 2002, the user inputs data watch parameters via the data watch creation UI. At 2102, the application 14 requests creation of a new data watch trigger from data analytics environment 100. At 2006, a creation success message can be set back to application 14 from data analytics environment 100. At 2008, the data analytics environment 100 configures the data watch object based on the parameters input by the user. At 2010, the condition is checked to see if it is met. If so, a notification is triggered at 2012 and a notification is displayed to the user (via application 14) at 2014.

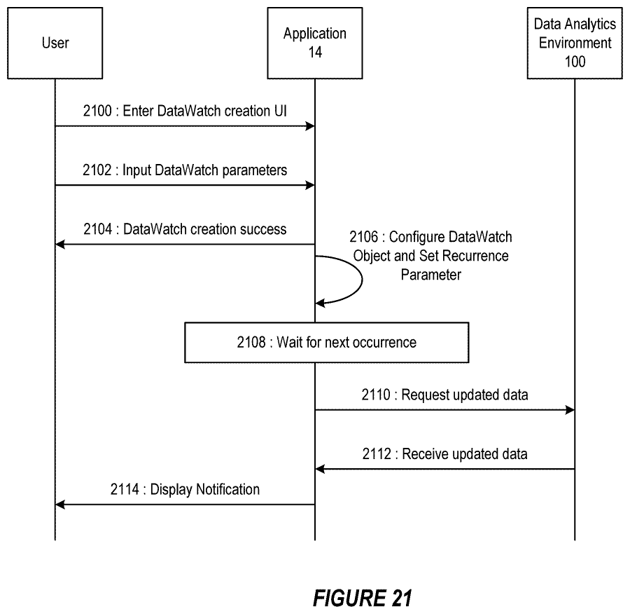

FIG. 21 illustrates an exemplary process for providing data watch rules and notifications for use with a data analytics environment, in accordance with an embodiment. In an example, FIG. 21 depicts the process for an on-device data watch object. As illustrated in FIG. 21, at 2000, the user enters the data watch creation UI of application 14. At 2102, the user inputs data watch parameters via the data watch creation UI. At 2104, the application 14 indicates creation success to the user. At 2106, the application 14 configures a data watch object based on the parameters input by the user. In an example, if the object is a recurrence type, the recurrence parameter is also set. According to this example, at 2108, the application 14 waits for the next occurrence of the configured interval. At the next occurrence, application 14, at 2110, can request updated data from the data analytics environment 100. At 2112, the application 14 receives the updated data. A notification is triggered and displayed to the user at 2114.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for providing notifications in a data analytics environment, comprising:
a computing device having one or more processors coupled to a memory having computer-executable instructions for an on-device application configured to interact with the data analytics environment, the instructions, when executed by the one or more processors, configure the computing device to:
receive user input indicative of parameters for a data watch construct;
configure the data watch construct based on the user input;
receive a trigger for a notification from the data watch construct when a configured condition is satisfied; and
display the notification to the user.

2. The system of claim 1, wherein the computing device is further configured to determine whether to generate the data watch construct as an on-device object or an on-server object based on at least one parameter indicated in the user input, and wherein the configured condition is checked by a server for the on-server object and wherein the computing device checks the configured condition for the on-device object.

3. The system of claim 1, wherein the configured condition relates to a data value, and
wherein the configured condition is satisfied when the data value, as indicated in data maintained by the data analytics environment, satisfies a predetermined relationship to a predetermined threshold.

4. The system of claim 1, wherein the configured condition relates to a recurrent time interval, and
wherein the configured condition is satisfied when the recurrent time interval elapses.

5. The system of claim 1, wherein the computing device is further configured to:
request updated data from the data analytics environment; and
receive the updated data in response to the request.

6. The system of claim 5, wherein the computing device is further configured to determine whether the configured condition is satisfied based on the updated data.

7. The system of claim 1, wherein the computing device is further configured to receive updated data with the notification.

8. A method for providing notifications in a data analytics environment, the method performed by a computing device having one or more processors coupled to a memory having computer-executable instructions for an on-device application configured to interact with the data analytics environment, the method comprising:
receiving user input indicative of parameters for a data watch construct;
configuring the data watch construct based on the user input;
receiving a trigger for a notification from the data watch construct when a configured condition is satisfied; and
displaying the notification to the user.

9. The method of claim 8, further comprising determining whether to generate the data watch construct as an on-device object or an on-server object based on at least one parameter indicated in the user input, and wherein the configured condition is checked by a server for the on-server object and wherein the computing device checks the configured condition for the on-device object.

10. The method of claim 8, wherein the configured condition relates to a data value, and
wherein the configured condition is satisfied when the data value, as indicated in data maintained by the data analytics environment, satisfies a predetermined relationship to a predetermined threshold.

11. The method of claim 8, wherein the configured condition relates to a recurrent time interval, and
wherein the configured condition is satisfied when the recurrent time interval elapses.

12. The method of claim 8, further comprising:
requesting updated data from the data analytics environment; and
receiving the updated data in response to the request.

13. The method of claim 12, further comprising determining whether the configured condition is satisfied based on the updated data.

14. The method of claim 8, further comprising receiving updated data with the notification.

15. A non-transitory computer readable storage medium, including instructions stored thereon for an on-device application configured to interact with the data analytics environment, the instructions, when read and executed by one or more computers, cause the one or more computers to:
receive user input indicative of parameters for a data watch construct;
configure the data watch construct based on the user input;
receive a trigger for a notification from the data watch construct when a configured condition is satisfied; and
display the notification to the user.

16. The non-transitory computer readable storage medium of claim 15, the instruction further cause the one or more computers to determine whether to generate the data watch construct as an on-device object or an on-server object based on at least one parameter indicated in the user input, and wherein the configured condition is checked by a server for the on-server object and wherein the computing device checks the configured condition for the on-device object.

17. The non-transitory computer readable storage medium of claim 15, wherein the configured condition relates to a data value, and
wherein the configured condition is satisfied when the data value, as indicated in data maintained by the data analytics environment, satisfies a predetermined relationship to a predetermined threshold.

18. The non-transitory computer readable storage medium of claim 15, wherein the configured condition relates to a recurrent time interval, and
wherein the configured condition is satisfied when the recurrent time interval elapses.

19. The non-transitory computer readable storage medium of claim 15, the instructions further cause the one or more computers to:
request updated data from the data analytics environment; and
receive the updated data in response to the request.

20. The non-transitory computer readable storage medium of claim 19, the instructions further cause the one or more computers to determine whether the configured condition is satisfied based on the updated data.
